(19) United States
(12) Patent Application Publication
(10) Pub. No.: US 2007/0016433 A1
(43) Pub. Date: Jan. 18, 2007

(54) Method and apparatus for ranking support materials for service agents and customers

(75) Inventors: Drew Leakey, Austin, TX (US); Adam Klein, Cedar Park, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/183,709

(22) Filed: Jul. 18, 2005

(51) Int. Cl. G06Q 99/00; G07G 1/00; G06F 17/30

(52) U.S. Cl. 705/1; 705/10

(57) ABSTRACT

An information management system (100) for managing support materials has a communications interface (110) coupled to customer service agents (112) and customers 108, a memory 104, and a processor 102. The processor is programmed to receive (202) customer feedback from one or more customer service agents, rank (203) support materials according to the customer feedback, and present (214) the support materials according to their respective rankings.

### FIELD OF THE INVENTION

This invention relates generally to managing support materials, and more particularly to a method and apparatus for ranking support materials for service agents and customers.

### BACKGROUND OF THE INVENTION

It is common for service providers to post materials on websites to provide its customers and customer service agents a reference of materials for support purposes (e.g., technical self-help articles). Some service providers track the number of times these materials are accessed by customers and/or agents as a means for ranking and updating said materials. This approach, however, is ad hoc in that there may not be consistent patterns between customer and agent usage. More importantly, the one-on-one contact between customers and agents is not captured in the foregoing ranking approach.

Accordingly, a need arises for a method and apparatus for ranking support materials for service agents and customers that overcomes the deficiencies in present systems.

### SUMMARY OF THE INVENTION

Embodiments in accordance with the invention provide a method and apparatus for ranking support materials for service agents and customers.

In a first embodiment of the present invention, an information management system for managing support materials has a communications interface coupled to customer service agents and customers, a memory, and a processor. The processor is programmed to receive customer feedback from one or more customer service agents, rank support materials according to the customer feedback, and present the support materials according to their respective rankings.

In a second embodiment of the present invention, an information management system for managing support materials has a computer-readable storage medium. The storage medium has computer instructions for receiving customer feedback from one or more customer service agents, ranking support materials according to the customer feedback, and presenting the support materials according to their respective rankings.

In a third embodiment of the present invention, an information management system for managing support materials operates according to a method having the steps of receiving customer feedback from one or more customer service agents, ranking support materials according to the customer feedback, and presenting the support materials according to their respective rankings.

### BRIEF DESCRIPTION OF THE DRAWINGS

FIG. 1 is block diagram of an information management system according to an embodiment of the present invention; and

FIG. 2 depicts a flowchart of a method operating in the information management system according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

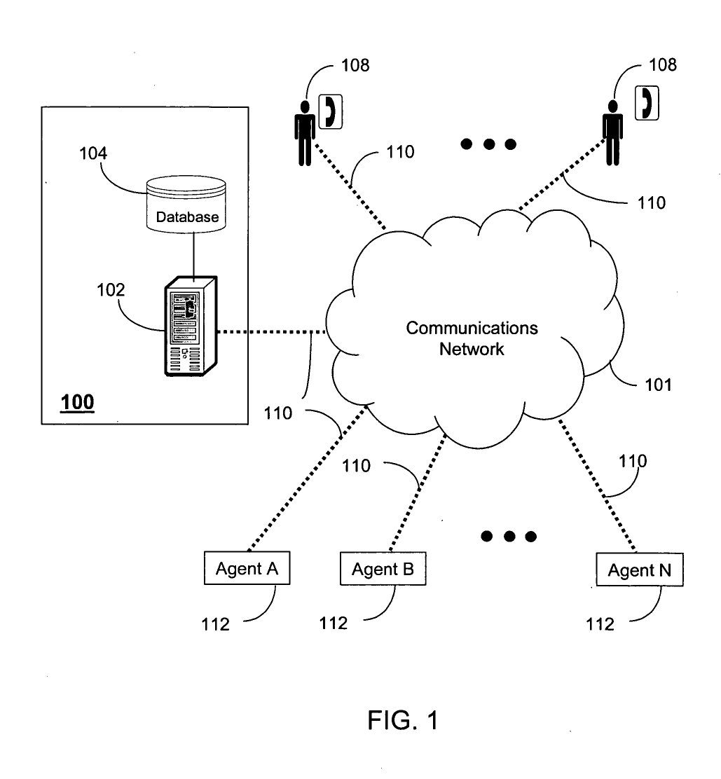

FIG. 1 is block diagram of an information management system (IMS) 100 according to an embodiment of the present invention. The IMS 100 comprises a communications interface 110, a memory 104 and a processor 102. The communications interface 110 is coupled a conventional communications network 101, which interconnects customers 108 and customer service agents 112 operating at, for example, a service center responsible for specific customer support tasks such as technical support, service installation, and so on. The communications network 101 and interfaces 110 coupled thereto operate according to any known communications technology such as wired or wireless circuit switched or packet switched networks. Accordingly, POTS (Plain Old Telephone Service) phones, cell phones, VoIP (Voice over Internet Protocol) phones, or other like telecommunication devices can be used for intercommunication purposes within the confines of the communications network 101.

The memory 104 can be utilized as a database for storing customer resolution support materials such as articles, whitepapers, or like materials for assisting customers 108 and/or service agents 112 in relation to services provided to said customers. Any database application and/or information management systems (such as a CRM—Customer Relations Management) application can be applied to the present invention. The processor 102 comprises conventional computing technology such as a desktop computer or scalable server for managing operations of the IMS 100 in accordance with the present invention.

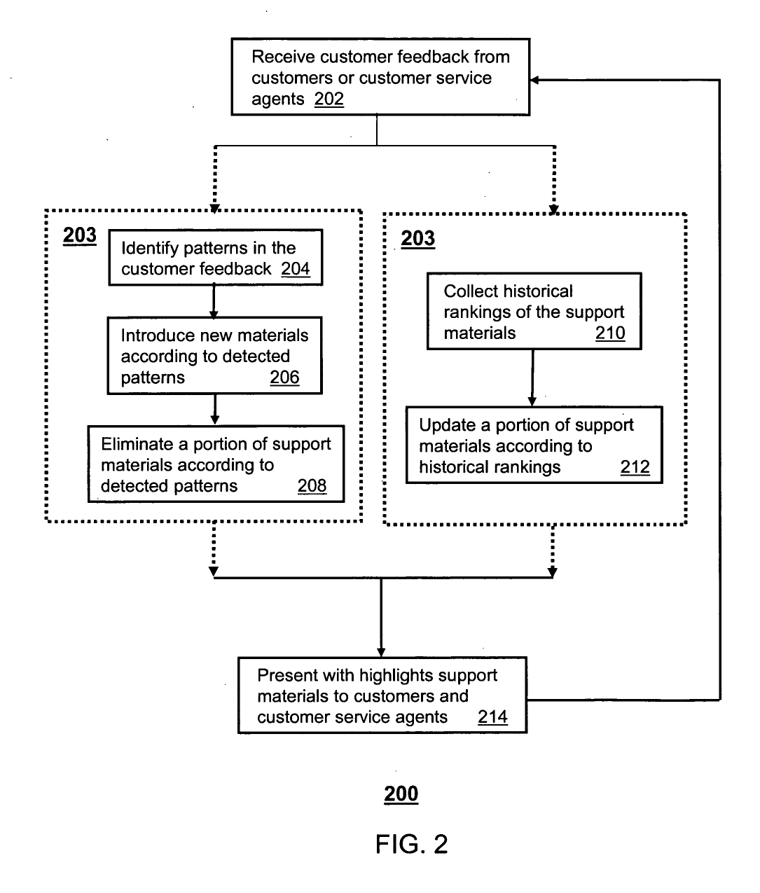

FIG. 2 depicts a flowchart of a method 200 operating in the IMS 100 according to an embodiment of the present invention. Method 200 begins with step 202 where the IMS 100 receives customer feedback from computer terminals of customers and/or customer service agents 112. This feedback can be in the form of support materials rankings and/or an order of importance of use of said materials. Customer feedback can comprise, for example, the top call drivers recorded by the customer service agents 112 or reports from customers indicating the top issues that a customer experiences when trouble shooting an issue on her computer. Customer feedback can further include an indication from customers and/or agents 112 as to the relevance of the support materials to supporting customer 108 calls.

Customers 108, for example, can have conventional software installed on their computers that identifies error dialogs or common errors from applications installed as part of the service provider's Internet service offered by way of the communication network 101. The software attempts to assist the customer in troubleshooting by way of a support website so the customer never has to call a human agent 112. Whether or not the issue is resolved, the software installed on the customer's computer reports metrics to IMS 100 indicating the top trouble areas of the customer. This customer feedback mechanism can be used as will be described below to rank the support materials presented at a support website.

Similar software can be installed in computer terminals utilized by customer service agents 112 to report customer feedback to the IMS 100 in cases where customers 108 call agents 112 for personal assistance. For example, as customer service agents 112 process calls from customers 108, each service agent can identify on a computer terminal of said agent which support material(s) have been selected for self-use by the agent or recommended to a customer according to the customer's needs to resolve a pending issue of said customer. The application running on said agents' computer can be remotely coupled to the IMS 100 so that as materials are selected by the agents, the IMS 100 tracks said selections individually.

Customer feedback can be provided to the IMS 100 in a real-time manner or at periodic intervals prompted by the IMS 100. For example, customer feedback can be provided by either of the computer terminals of the customers 108 and agents 112 as an accumulated ranking of materials which is received by the IMS 100 at periodic intervals (e.g., midday or close of business each day). In this embodiment, selections made by the customers 108 or customer service agents 112 (or autonomously by the software in their computer) are collected during the course of a day, and reported to the IMS 100 periodically in response to a request from the IMS 100.

It would be obvious to one of ordinary skill in the art that there are many methods for conveying customer feedback from a computer terminal of a customer 108 and/or a customer service agent 112 that that can be successfully applied to the present invention. Accordingly, any such methods not described herein for conveying customer feedback to the IMS 100 are considered to be within the scope of the claimed invention.

From the customer feedback, the IMS 100 ranks in step 203 the support materials. Steps 204 through 208, and steps 210 and 212, respectively, represent first and second embodiments for establishing support material rankings. It would be obvious to one of ordinary skill in the art that the embodiment of step 203 as shown in FIG. 2 can be modified in numerous ways without departing from the claimed invention. Accordingly, any modifications and/or enhancements to the embodiment of step 203 as presented below are considered to be within the spirit of the claims described herein.

A first embodiment of step 203 begins with step 204 where the IMS 100 is programmed to identify patterns in the customer feedback. Conventional statistical tools can be applied to this step to identify in an automated fashion use patterns in the support materials recommended by agents 112 (or for their own use). In step 206, the IMS 100 can be programmed to introduce new support materials and/or eliminate in step 208 a portion of the existing support materials according to patterns identified in step 204. The introduction step 206 can be performed by searching the database of the memory 104, which can include a large library of support materials by subject or category that can be indexed according to the pattern(s) detected in step 204. The elimination step, can reflect the elimination of one or more articles from the support materials for lack of use, or a determination that said articles lack relevant subject matter. The net result of steps 204 through 208 can produce updated support materials arranged by ranking.

In an alternative embodiment, step 203 begins with step 210 where the IMS 100 is programmed to collect historical rankings of the support materials. The historical rankings can be a periodic accumulation of prior rankings in which the IMS 100 can average or apply conventional statistical analysis thereto to determine use patterns and/or trends. In step 212, the IMS 100 can be programmed to update a portion of the support materials according to said historical rankings. The updating step can be similar to steps 206 and 208 where new support materials can be introduced and old ones can be eliminated for any number of reasons such as lack of use or relevance to customers 108 and/or agents 112.

In step 214, the IMS 100 is programmed to present to customers 108 and/or customer service agents 112 the updated support materials according to their respective rankings as determined in step 203. The presentation step can be accomplished by way of a conventional website provided by the IMS 100 to customers 108 and/or agents 112 through the communications network 101. Additionally, the IMS 100 can be programmed to highlight these rankings in any conventional manner such as, for example, by the order of presentation (e.g., most popular article listed first), by indicating number of accesses from prior customers 108 or agents 112, and/or other conventional highlighting methods singly or in combination that may be useful for conveying a ranking strategy for said support materials. From step 214, the IMS 100 is programmed to repeatedly apply the foregoing embodiments in order to maintain updated support materials and their respective rankings for customers 108 and agents 112.

It should be evident by now that the present invention can be realized in hardware, software, or a combination of hardware and software. Moreover, the present invention can be realized in a centralized fashion, or in a distributed fashion where different elements are spread across several interconnected processors. Thus, any kind of computing device or other apparatus adapted for carrying out method 200 described above is suitable for the present invention.

It should be also evident that the present invention may be used for many applications. Thus, although the description is made for particular arrangements and methods, the intent and concept of the invention is suitable and applicable to other arrangements and applications not described herein. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein. A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. An information management system for managing support materials, comprising:
a communications interface coupled to customer service agents and customers;
a memory; and
a processor, wherein the processor is programmed to:
receive customer feedback from at least one among customer service agents and customers;
rank support materials according to the customer feedback; and
present the support materials according to their respective rankings.

2. The information management system of claim 1, wherein the processor is programmed to receive an order of importance for support materials from at least one among computer terminals of customer service agents and customers.

3. The information management system of claim 1, wherein the processor is programmed to present the ranked support materials to at least one among customers and customer service agents.

4. The information management system of claim 1, wherein the processor is programmed to:
collect historical rankings of the support materials;
update a portion of the support materials according to historical rankings; and
present the reduced set of support materials according to its respective rankings.

5. The information management system of claim 1, wherein the processor is programmed to highlighting rankings of support materials in the presentation step.

6. The information management system of claim 1, wherein customer feedback comprises top call drivers recorded by at least one among computer terminals of customer service agents and customers.

7. The information management system of claim 1, wherein the processor is programmed to:
identifying patterns in the customer feedback;
introducing new materials to the support materials according to said patterns; and
eliminating a portion of the support materials according to said patterns.

8. In an information management system for managing support materials, a computer-readable storage medium comprising computer instructions for:
receiving customer feedback from at least one among customer service agents and customers;
ranking support materials according to the customer feedback; and
presenting the support materials according to their respective rankings.

9. The storage medium of claim 8, comprising computer instructions for receiving an order of importance for support materials from at least one among computer terminals of customer service agents and customers.

10. The storage medium of claim 8, comprising computer instructions for presenting the ranked support materials to at least one among customers and customer service agents.

11. The storage medium of claim 8, comprising computer instructions for:
collecting historical rankings of the support materials;
updating a portion of the support materials according to historical rankings; and
presenting the reduced set of support materials according to its respective rankings.

12. The storage medium of claim 8, comprising computer instructions for highlighting rankings of support materials in the presentation step.

13. The storage medium of claim 8, wherein customer feedback comprises top call drivers recorded by at least one among computer terminals of customer service agents and customers.

14. The storage medium of claim 8, comprising computer instructions for:
identifying patterns in the customer feedback;
introducing new materials to the support materials according to said patterns; and
eliminating a portion of the support materials according to said patterns.

15. In an information management system for managing support materials, a method comprising the steps of:
receiving customer feedback from at least one among customer service agents and csutomers;
ranking support materials according to the customer feedback; and
presenting the support materials according to their respective rankings.

16. The method of claim 15, comprising the step of receiving an order of importance for support materials from at least one among computer terminals of customer service agents and customers.

17. The method of claim 15, comprising the step of presenting the ranked support materials to at least one among customers and customer service agents.

18. The method of claim 15, comprising the steps of:
collecting historical rankings of the support materials;
updating a portion of the support materials according to historical rankings; and
presenting the reduced set of support materials according to its respective rankings.

19. The method of claim 15, comprising the step of highlighting rankings of support materials in the presentation step.

20. The method of claim 15, comprising the steps of:
identifying patterns in the customer feedback;
introducing new materials to the support materials according to said patterns; and
eliminating a portion of the support materials according to said patterns.
